(19) United States
(12) Patent Application Publication
(10) Pub. No.: US 2011/0067522 A1
(43) Pub. Date: Mar. 24, 2011

(54) BICYCLE HANDLEBAR GRIP

(76) Inventor: CHING -CHUAN LAI, Taichung City (TW)

(21) Appl. No.: 12/954,873

(22) Filed: Nov. 28, 2010

Related U.S. Application Data
(63) Continuation-in-part of application No. 11/745,583, filed on May 8, 2007.

(30) Foreign Application Priority Data
Nov. 28, 2008 (TW) 097221332

(51) Int. Cl. B62K 21/26

(52) U.S. Cl. 74/551.9

(57) ABSTRACT

A bicycle handlebar grip contains a plastic inner shell having a tubular shape and an outer surface; a fiber layer having an inner surface and an outer surface and includes a plurality of fibers interweaving with each other and a plurality of weaving gaps located between the fibers; a plastic layer enclosed around the outer surface of the fiber layer and combined with the fiber layer integrally and including a holding portion coated on the outer surface of the fiber layer, an engaging portion penetrating through the weaving gaps if the fiber layer, and a permeating portion extending through the weaving gaps of the fiber layer into the inner surface of the fiber layer, and the permeating portion of the plastic layer is combined with the outer surface of the plastic inner shell integrally.

This application is a Continuation-in-Part of application Ser. No. 11/745,583, filed May 8, 2007.

### BACKGROUND OF THE INVENTION

1. Field of the Invention

The present invention relates to a grip and more particularly, to a bicycle handlebar grip.

2. Description of the Prior Art

A conventional bicycle handlebar grip comprises a tubular member made of a composite material, and a plastic sleeve mounted on the tubular member in a close fit manner. The composite material consists of a substrate, such as an epoxy, and a reinforcement, such as a carbon fiber. However, it is necessary to coat a protective layer on the surface of the tubular member to facilitate mounting the plastic sleeve onto the tubular member and to prevent the tubular member from being scratched by the plastic sleeve, so that the conventional bicycle handlebar grip has a complicated working process, thereby increasing the costs of fabrication. In addition, the plastic sleeve is mounted on the tubular member in a manual manner, thereby decreasing the quality of the product and increasing the costs of fabrication. Further, the plastic sleeve is not combined with the tubular member closely, thereby decreasing the structural strength of the bicycle handlebar grip. Further, water or dust easily enters the gap between the plastic sleeve and the tubular member thereby causing a sanitary problem. Further, the plastic sleeve is formed by extruding so that the plastic sleeve has fixed patterns and shapes, thereby decreasing the outer appearance of the bicycle handlebar grip.

The present invention has arisen to mitigate and/or obviate the afore-described disadvantages.

### SUMMARY OF THE INVENTION

The primary objective of the present invention is to provide a bicycle handlebar grip having an enhanced combination strength.

Another objective of the present invention is to provide a bicycle handlebar grip and a method for making the grip, wherein the bicycle handlebar grip comprises an inner fiber layer and an outer plastic layer, wherein the fiber layer is light and hard to reduce the weight and increase the structural strength of the bicycle handlebar grip, while the plastic layer is soft and has an adjustable thickness to provide a comfortable sensation to a user when holding the bicycle handlebar grip.

A further objective of the present invention is to provide a bicycle handlebar grip and a method for making the grip, wherein the holding portion of the plastic layer is molded in the die to form different spatial patterns and shapes to enhance the outer appearance of the bicycle handlebar grip and to facilitate the user holding the bicycle handlebar grip.

A further objective of the present invention is to provide a bicycle handlebar grip and a method for making the grip, wherein the plastic layer is made of a transparent material so that the fibers of the fiber layer are viewable outwardly from the plastic layer to enhance the aesthetic quality of the bicycle handlebar grip.

A further objective of the present invention is to provide a bicycle handlebar grip and a method for making the grip, wherein the plastic layer includes a holding portion coated on the outer surface of the fiber layer, an engaging portion penetrating through the weaving gaps of the fiber layer, and a permeating portion extending through the weaving gaps of the fiber layer into the inner surface of the fiber layer to enhance the combination strength between the fiber layer and the plastic layer and to enhance the structural strength of the bicycle handlebar grip.

A further objective of the present invention is to provide a bicycle handlebar grip and a method for making the grip, wherein the fiber layer is combined with the plastic layer integrally to prevent water or dust from passing between the fiber layer and the plastic layer.

A further objective of the present invention is to provide a bicycle handlebar grip and a method for making the grip, wherein the plastic layer is molded in the die so that the bicycle handlebar grip is made automatically to increase the quality of the product and to reduce the costs of fabrication.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bicycle handlebar grip in accordance with the preferred embodiment of the present invention.

FIG. 2 is a top view showing expansion of a fiber layer of the bicycle handlebar grip as shown in FIG. 1.

FIG. 3 is a cross-sectional view of the fiber layer of the bicycle handlebar grip taken along line 3-3 as shown in FIG. 2.

FIG. 4 is a cross-sectional view showing the fiber layer of the bicycle handlebar grip being placed into a die.

FIG. 5 is a cross-sectional view of the bicycle handlebar grip as shown in FIG. 1.

FIG. 6 is a perspective view of a bicycle handlebar grip in accordance with another preferred embodiment of the present invention.

FIG. 7 is a cross-sectional view of the bicycle handlebar grip as shown in FIG. 6.

FIG. 8 is a flow chart of a method for making the grip as shown in FIG. 1.

FIG. 9 is a flow chart of a method for making the grip as shown in FIG. 6.

### DETAILED DESCRIPTION OF THE PREFERRED EMBODIMENTS

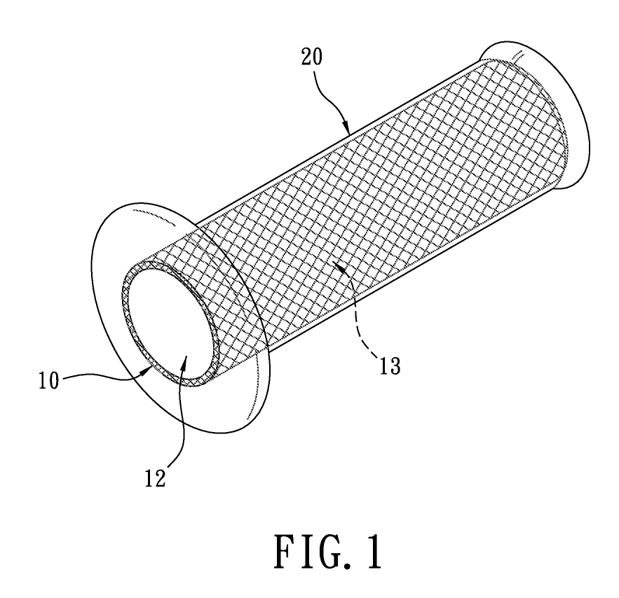

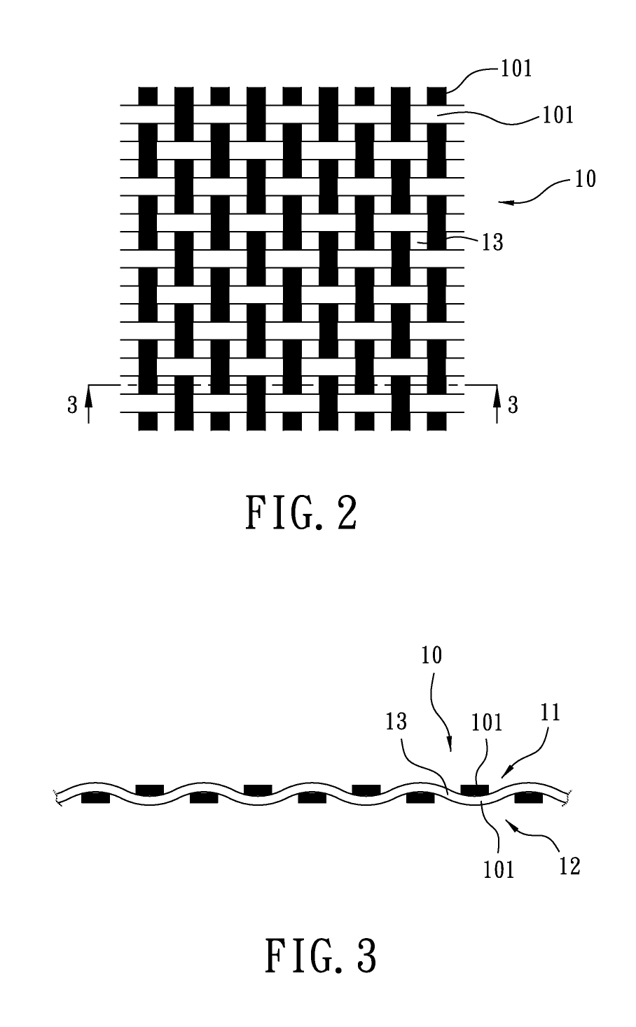

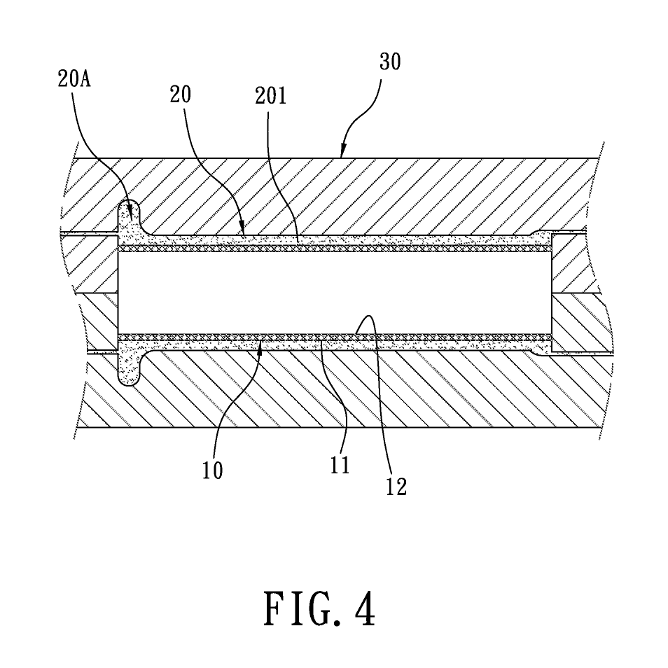

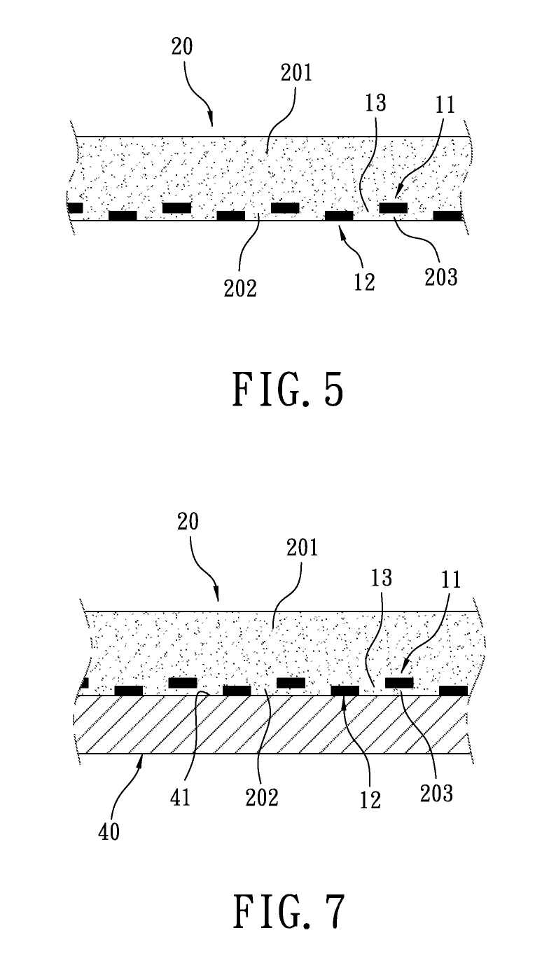

Referring to the drawings and initially to FIGS. 1-5, a bicycle handlebar grip in accordance with the preferred embodiment of the present invention comprises an inner fiber layer 10 and an outer plastic layer 20.

The fiber layer 10 has an inner surface 12 and an outer surface 11 and includes a plurality of fibers 101 interweaving with each other and a plurality of weaving gaps 13 located between the fibers 101. The fiber layer 10 has a substantially tubular shape. The fiber layer 10 is made of a fiber cloth and preferably made of a carbon fiber cloth. The weaving gaps 13 of the fiber layer 10 are distributed between the fibers 101 evenly and connected with each other. The weaving gaps 13 of the fiber layer 10 are at least distributed on the inner surface 12 of the fiber layer 10. In the preferred embodiment of the present invention, the weaving gaps 13 of the fiber layer 10 are distributed between the outer surface 11 and the inner surface 12 of the fiber layer 10 evenly.

The plastic layer 20 is enclosed around the outer surface 11 of the fiber layer 10 and combined with the fiber layer 10 integrally. The plastic layer 20 includes a holding portion 201 coated on the outer surface 11 of the fiber layer 10 and an engaging portion 202 penetrating through the weaving gaps 13 of the fiber layer 10. The plastic layer 20 further includes a permeating portion 203 extending through the weaving gaps 13 of the fiber layer 10 into the inner surface 12 of the fiber layer 10. The plastic layer 20 is made of a transparent material so that the fibers 101 of the fiber layer 10 are viewable outwardly from the plastic layer 20. In the preferred embodiment of the present invention, the plastic layer 20 is made of polyethylene (PE), polypropylene (PP), thermoplastic elastomer (TPE) or thermoplastic rubber (TPR).

In fabrication, the fiber layer 10 is placed into a die 30, a determined of melted plastic material 20 A is filled into the die 30 to enclose around the outer surface 11 of the fiber layer 10 to form the plastic layer 20 so that the plastic layer 20 is combined with the fiber layer 10 integrally.

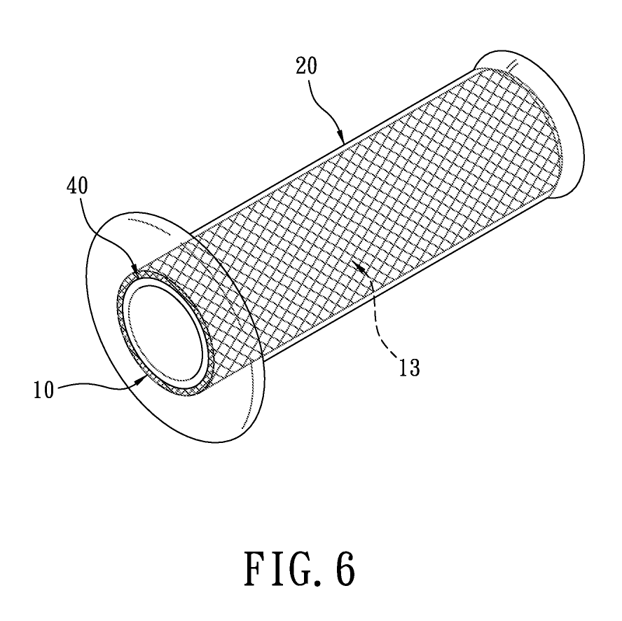

Referring to FIGS. 6 and 7, the bicycle handlebar grip further comprises a plastic inner shell 40 mounted in the fiber layer 10 and having an outer surface 41 rested on the inner surface 12 of the fiber layer 10. Preferably, the plastic inner shell 40 has a tubular shape and the outer surface 41 of the plastic inner shell 40 is combined with the permeating portion 203 of the plastic layer 20 integrally.

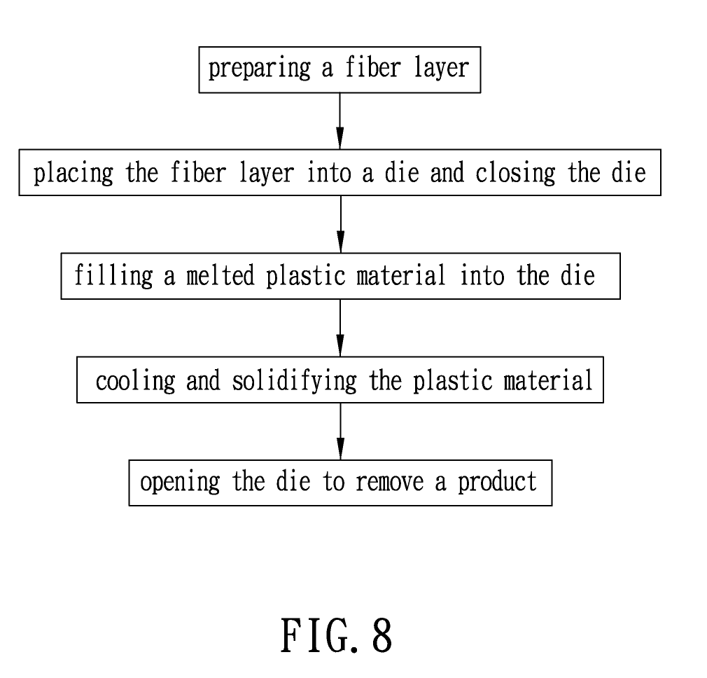

Referring to FIG. 8 with reference to FIGS. 1-5, a method for making the grip comprises the steps of: a) preparing a fiber layer 10 which has an inner surface 12 and an outer surface 11 and includes a plurality of fibers 101 interweaving with each other and a plurality of weaving gaps 13 located between the fibers 101, b) placing the fiber layer 10 into a die 30 and closing the die 30, c) filling a melted plastic material 20 A into the die 30 to encompass the outer surface 11 of the fiber layer 10 and to penetrate through the weaving gaps 13 of the fiber layer 10, d) cooling and solidifying the plastic material to form a plastic layer 20 which includes a holding portion 201 coated on the outer surface 11 of the fiber layer 10 and an engaging portion 202 penetrating through the weaving gaps 13 of the fiber layer 10; and e) opening the die 30 to remove a product which comprises the fiber layer 10 and the plastic layer 20 enclosed around the outer surface 11 of the fiber layer 10 and combined with the fiber layer 10 integrally.

In the preferred embodiment of the present invention, the melted plastic material 20 A further extends through the weaving gaps 13 of the fiber layer 10 into the inner surface 12 of the fiber layer 10, so that the plastic layer 20 further includes a permeating portion 203 extending through the weaving gaps 13 of the fiber layer 10 into the inner surface 12 of the fiber layer 10. In addition, the outer surface 11 of the fiber layer 10 is previously coated with a bonding agent which is heated in the die 30 and is disposed at a melted state to combine with the melted plastic material 20 A integrally. Preferably, the bonding agent is made of a thermoplastic material.

Thus, the fibers 101 of the fiber layer 10 are bonded and formed by the bonding agent to prevent the fibers 101 of the fiber layer 10 from being displaced and deformed so that the fiber layer 10 maintains a tubular shape. In addition, when the melted plastic material 20 A into the die 30 is filled into the die 30, both of the bonding agent and the melted plastic material 20 A are made of the same material which is a thermoplastic material, so that the bonding agent is melted by the high temperature of the die 30 and the melted plastic material 20 A to combine with the melted plastic material 20 A integrally. Thus, the bonding agent is movable with the melted plastic material 20 A to encompass the outer surface 11 of the fiber layer 10, to penetrate through the weaving gaps 13 of the fiber layer 10, and to extend through the weaving gaps 13 of the fiber layer 10 into the inner surface 12 of the fiber layer 10.

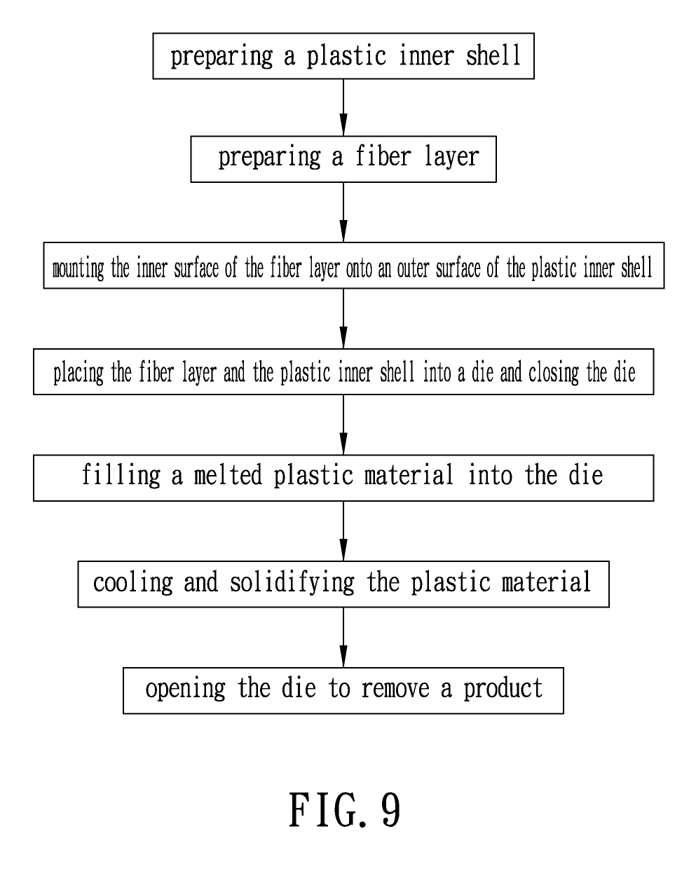

Referring to FIG. 9 with reference to FIGS. 1-7, a method for making the grip comprises the steps of: a) preparing a plastic inner shell 40, b) preparing a fiber layer 10 which has an inner surface 12 and an outer surface 11 and includes a plurality of fibers 101 interweaving with each other and a plurality of weaving gaps 13 located between the fibers 101, c) mounting the inner surface 12 of the fiber layer 10 onto an outer surface 41 of the plastic inner shell 40, d) placing the fiber layer 10 and the plastic inner shell 40 into a die 30 and closing the die 30, e) filling a melted plastic material 20 A into the die 30 to encompass the outer surface 11 of the fiber layer 10 and to penetrate through the weaving gaps 13 of the fiber layer 10, t) cooling and solidifying the plastic material to form a plastic layer 20 which includes a holding portion 201 coated on the outer surface 11 of the fiber layer 10 and an engaging portion 202 penetrating through the weaving gaps 13 of the fiber layer 10; and g) opening the die 30 to remove a product which comprises the plastic inner shell 40, the fiber layer 10 mounted on the plastic inner shell 40 and the plastic layer 20 enclosed around the outer surface 11 of the fiber layer 10.

In the preferred embodiment of the present invention, the melted plastic material 20 A further extends through the weaving gaps 13 of the fiber layer 10 into the inner surface 12 of the fiber layer 10, so that the plastic layer 20 further includes a permeating portion 203 which extends through the weaving gaps 13 of the fiber layer 10 into the inner surface 12 of the fiber layer 10 and is combined with the outer surface 41 of the plastic inner shell 40. In addition, the outer surface 11 of the fiber layer 10 is previously coated with a bonding agent which is heated in the die 30 and is disposed at a melted state to combine with the melted plastic material 20 A. Preferably, the bonding agent is made of a thermoplastic material.

Thus, the fibers 101 of the fiber layer 10 are bonded and formed by the bonding agent to prevent the fibers 101 of the fiber layer 10 from being displaced and deformed so that the fiber layer 10 maintains a tubular shape. In addition, when the melted plastic material 20 A into the die 30 is filled into the die 30, both of the bonding agent and the melted plastic material 20 A are made 10 of the same material which is a thermoplastic material, so that the bonding agent is melted by the high temperature of the die 30 and the melted plastic material 20 A to combine with the melted plastic material 20 A integrally. Thus, the bonding agent is movable with the melted plastic material 20 A to encompass the outer surface 11 of the fiber layer 10, to penetrate through the weaving gaps 13 of the fiber layer 10, and to extend through the weaving gaps 13 of the fiber layer 10 into the inner surface 12 of the fiber layer 10.

Accordingly, the bicycle handlebar grip comprises an inner fiber layer 10 and an outer plastic layer 20, wherein the fiber layer 10 is light and hard to reduce the weight and increase the structural strength of the bicycle handlebar grip, while the plastic layer 20 is soft and has an adjustable thickness to provide a comfortable sensation to a user when holding the bicycle handlebar grip. In addition, the holding portion 201 of the plastic layer 20 is molded in the die 30 to form different spatial patterns and shapes to enhance the outer appearance of the bicycle handlebar grip and to facilitate the user holding the bicycle handlebar grip. Further, the plastic layer 20 is made of a transparent material so that the fibers 101 of the fiber layer 10 are viewable outwardly from the plastic layer 20 to enhance the aesthetic quality of the bicycle handlebar grip. Further, the plastic layer 20 includes a holding portion 201 coated on the outer surface 11 of the fiber layer 10, an engaging portion 202 penetrating through the weaving gaps 13 of the fiber layer 10, and a permeating portion 203 extending through the weaving gaps 13 of the fiber layer 10 into the inner surface 12 of the fiber layer 10 to enhance the combination strength between the fiber layer 10 and the plastic layer 20 and to enhance the structural strength of the bicycle handlebar grip. Further, the fiber layer 10 is combined with the plastic layer 20 integrally to prevent water or dust from passing between the fiber layer 10 and the plastic layer 20. Further, the plastic layer 20 is molded in the die 30 so that the bicycle handlebar grip is made automatically to increase the quality of the product and to reduce the costs of fabrication.

It is to be noted that the step of coating the bonding agent is used to combine the fiber layer 10 with the outer surface 41 of the plastic inner shell 40 together before forming the plastic layer 20, therefore the method to combine the fiber layer 10 with the outer surface 41 of the plastic inner shell 40 is limited to only coating the bonding agent. For example, a two-sided rubber (not shown) is also capable of being used to combine the fiber layer 10 with the outer surface 41 of the plastic inner shell 40 together.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A bicycle handlebar grip comprising
a plastic inner shell having a tubular shape and an outer surface;
a fiber layer having an inner surface and an outer surface and includes a plurality of fibers interweaving with each other and a plurality of weaving gaps located between the fibers;
a plastic layer enclosed around the outer surface of the fiber layer and combined with the fiber layer integrally and including a holding portion coated on the outer surface of the fiber layer, an engaging portion penetrating through the weaving gaps if the fiber layer, and a permeating portion extending through the weaving gaps of the fiber layer into the inner surface of the fiber layer, and the permeating portion of the plastic layer is combined with the outer surface of the plastic inner shell integrally.

2. The bicycle handlebar grip as claimed in claim 1, wherein the fiber layer is made of a carbon fiber cloth

3. The bicycle handlebar grip as claimed in claim 1, wherein the fiber layer is combined with the outer surface of the plastic inner shell together by using a two-sided rubber, and then the plastic inner shell is formed.

4. The bicycle handlebar grip as claimed in claim 1, wherein the fiber layer is combined with the outer surface of the plastic inner shell together by using a bonding agent, and then the plastic inner shell is formed, the bonding agent is heated in a die and is disposed at a melted state to combine with the melted plastic material integrally, and when the melted plastic material into the die is filled into the die, both of the bonding agent and the melted plastic material are made of the same material.

5. The bicycle handlebar grip as claimed in claim 4, wherein the bonding agent is made of a thermoplastic material.
